(19) United States
(12) Patent Application Publication
(10) Pub. No.: US 2022/0035071 A1
(43) Pub. Date: Feb. 3, 2022

(54) PORE-SCALE, MULTI-COMPONENT, MULTI-PHASE FLUID MODEL AND METHOD

(71) Applicant: KING ABDULLAH UNIVERSITY OF SCIENCE AND TECHNOLOGY, Thuwal (SA)

(72) Inventors: Shuyu SUN, Thuwal (SA); Tao ZHANG, Thuwal (SA); Xiaolin FAN, Thuwal (SA); Yiteng LI, Thuwal (SA); Jingfa LI, Thuwal (SA)

(21) Appl. No.: 17/298,969

(22) PCT Filed: Nov. 5, 2019
(86) PCT No.: PCT/IB2019/059501

§ 371 Date: Jun. 2, 2021

Related U.S. Application Data
(60) Provisional application No. 62/780,575, filed on Dec. 17, 2018.

(51) Int. Cl. G01V 99/00; G06F 30/28

(52) U.S. Cl. CPC G01V 99/005; E21B 47/10; G06F 30/28

(57) ABSTRACT

A method for calculating a fluid flow in a given underground medium, the method including receiving initial molar densities for components of the fluid; introducing a scalar auxiliary variable r into an inhomogeneous Helmholtz free energy equation F with a Peng-Robinson equation of state; calculating a molar density nᵢ of each component of the fluid based on a discretized scalar auxiliary variable r^{k}; and determining the flow of the fluid based on the calculated molar densities nᵢ.

### CROSS-REFERENCE TO RELATED APPLICATIONS

This application claims priority to U.S. Provisional Patent Application No. 62/780,575, filed on Dec. 17, 2018, entitled “PORE-SCALE, MULTI-COMPONENT, MULTI-PHASE FLUID MODEL AND METHOD,” the disclosure of which is incorporated herein by reference in its entirety.

### BACKGROUND

### Technical Field

Embodiments of the subject matter disclosed herein generally relate to a method for calculating compressible, multi-component, multi-phase fluid flows with partial miscibility based on realistic equations of state, within a given medium.

### Discussion of the Background

In reservoir engineering and chemical flow, it is desired to calculate a fluid flow through a porous medium. Thus, the study of multi-component and multi-phase fluid systems plays an important role in the thorough and accurate understanding of flow behaviors in a large range of applications. For example, in reservoir engineering, when a numerical simulation is performed to estimate the amount of oil stored in the reservoir and the best way to extract that oil, it is desired to determine whether the studied fluid (e.g., oil and water) can remain in one single phase or will split into multi phases including oil phase, water phase, gas phase, etc.

Thermodynamic equilibrium conditions are the basic rules to control the physical properties of the mixture fluid flow, such as composition, density and whether the phase split occurs. Recently, a realistic equation of state (e.g., Peng-Robinson equation of state as introduced in [1]) has attracted interest to being incorporated into the multi-component, multi-phase flow simulation to study the thermodynamical mechanism as it can be applied in many areas, especially in pore scale modeling of subsurface fluid flow [2, 3, 4]. In this regard, the main cause of capillarity, a major immiscible two-phase flow mechanism for systems with a strong wettability preference, is often attributed onto the surface tension, which is mainly determined by the phase behaviors of the multi-component fluids. To better capture the phase properties and behaviors of the various fluids, diffuse interphase models based on Peng-Robinson equation of state have been widely studied in recent years.

To understand the physical phenomena involving multiple phases, such as liquid droplets, gas bubbles, and phase change and separation, it is necessary to model and simulate the interface between these phases. Understanding and modeling the interface between phases have been approached by at least three main methodologies at different scales. In the first methodology, Molecular Dynamics and Monte Carlo methods are the main microscopic approaches, which are computationally more challenging as well as more accurate. In the second methodology, which is known as the sharp interface model, a zero-thickness, two-dimensional entity is used to model the interface, where the molar density experiences a jump across the interface.

The third approach is known as the diffuse interface model, gradient theory, or phase field theory. In this approach, the interface between two phases is described as a continuum three-dimensional entity which separates the two bulk single-phase fluid regions. The traditional diffuse interface model, e.g., Cahn Hilliard Equation, lacks consistency with the thermodynamics equations, which challenges the energy dissipation property of the numerical scheme, and thus, the simulation time step is limited to a large order. Some new developments were proposed, with van der Waals equation of state considered and incorporated with the hydrodynamic equations (N-S equations), and this improvement is called the “Dynamic van der Waals” model (see [5]).

For a multi-component, two-phase flow model using the Peng-Robinson equation of state, the main challenge is the strong non-linearity of the bulk Helmholtz free energy density. Besides this problem, the tight coupling relationship of the molar densities and flow velocity through the convection term in the mass equation and stress force arises from the momentum balance equation. A method that tried to overcome these deficiencies was developed based on a convex-concave splitting of the Helmholtz free energy, which leads to a non-linear and coupled system of mass and momentum balance equations [6].

However, the existing methods are still time and computer intensive as non-linearities are present in the equations to be solved. Thus, there is a need for a new method that can simulate compressible, multi-component, multi-phase flows with partial miscibility based on realistic equations of state and also can reduce the time necessary for a computing system for determining the flow.

### SUMMARY

According to another embodiment, there is a method for calculating a fluid flow in a given underground medium, the method including receiving initial molar densities for components of the fluid; introducing a scalar auxiliary variable r into an inhomogeneous Helmholtz free energy equation F with a Peng-Robinson equation of state; calculating a molar density nᵢ of each component of the fluid based on a discretized scalar auxiliary variable r^{k}; and determining the flow of the fluid based on the calculated molar densities nᵢ.

According to another embodiment, there is a computing device for calculating a fluid flow in a given underground medium, the computing device including an interface for receiving initial molar densities for components of the fluid; and a processor connected to the interface. The processor is configured to apply a scalar auxiliary variable r to an inhomogeneous Helmholtz free energy equation with a Peng-Robinson equation of state; calculate a molar density nᵢ of each component of the fluid based on a discretized scalar auxiliary variable; and determine the flow of the fluid based on the calculated molar densities nᵢ.

According to still another embodiment, there is a non-transitory computer readable medium including computer executable instructions, wherein the instructions, when executed by a processor, implement instructions for calculating a fluid flow in a given underground medium, as discussed herein.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates an interface between two phases of a fluid;

FIG. 2 is a flowchart of a method for calculating a flow of a fluid having a single component;

FIG. 3 is a flowchart of a method for calculating a flow of a fluid having plural components;

FIGS. 4A to 4D illustrate an oil droplet calculated with the above method;

FIG. 5 illustrates that a mass of the model used to calculate the flow of fluid is stable and FIG. 6 illustrates that the energy of the fluid is decreasing in time;

FIG. 7 compares the CPU time for calculating the fluid flow with the present method and a traditional convex-splitting method;

FIGS. 8A to 8D illustrate how the present method calculates the interface between a liquid component and a gas component for a fluid flow;

FIGS. 9A and 9B illustrate the mass conservation for the fluid flow;

FIG. 10 illustrates that the total free energy of the fluid flow dissipates;

FIGS. 11A to 11F illustrate the movement of three droplets of oil in water, when released from a vertical electrode and calculated with the method of FIG. 3;

FIGS. 12A to 12F illustrate the movement of three droplets of oil in water, when released from a horizontal electrode and calculated with the method of FIG. 3;

FIG. 13 illustrates the rising velocity of the droplets illustrated in FIGS. 11A to 12F;

FIG. 14 illustrates the rising velocity of oil droplets in water as a function of the temperature; and

FIG. 15 illustrates a computing system that implements one or more of the methods discussed herein.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a flow of oil and water in the subsurface of the earth. However, the embodiments discussed herein are applicable to other fluids in other media.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a linear and decoupled numerical scheme is developed for a multi-component, multi-phase fluid flow, which is also energy stable (i.e., to keep consistent with the Thermodynamic second law, the total energy in a system should decay), and which can speed up the calculations performed by a computing system. The scheme is designed to ensure the physical consistency of the various parameters of the described subsurface. According to this embodiment, a new comprehensive model is able to simulate the multi-component, multi-phase fluid flow, based on incorporating a realistic equation of state (e.g., Peng-Robinson equation of state) with the Diffuse Interface Model and also using the scalar auxiliary variable (SAV). The next paragraphs describe the basic thermodynamic formulations based on the Peng-Robinson equation of state for a single component fluid. Then, a linear evolution of the molar density, as well as the SAV intermediate term, are derived and the computation scheme is then detailed. Afterwards, the single-component system is extended to a multi-component system using a similar process. Furthermore, some examples are presented to illustrate the improvements achieved by the novel scheme for a realistic petroleum industry example. Then, the robustness and efficiency of the new scheme are verified through comparisons with existing experimental data.

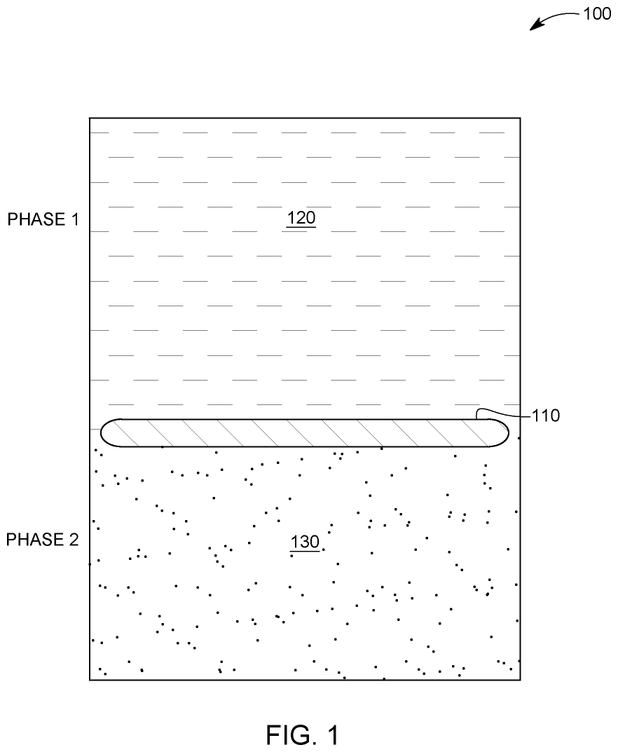

The Peng-Robison equation of state for the single component fluid is now discussed in preparation of introducing the novel scheme. Note that the Peng-Robinson equation of state describes a gas under given conditions, relating to pressure, temperature and a volume of the constituent matter. A real homogeneous fluid system 100 having a single component is considered to have a diffuse interface 110 between two phases 120 and 130, as illustrated in FIG. 1. To describe the phenomenon around the interface 110, the diffuse interface model with the gradient contribution is selected. For this scheme, the Helmholtz free energy is used as the kernel. For describing the behavior of the system at the interface 110, this approach uses not only the homogeneous Helmholtz free energy density f₀(n), but also a gradient term f_{∇}(n):

f(n)=f₀(n)+f_{∇}(n), (1)

where f(n) is the total (inhomogeneous) Helmholtz energy, and n is the molar density, which represents the particle number per unit volume for the single component as given by equation:

$$n = \frac{N}{V} . \qquad ( 2 )$$

The homogeneous Helmholtz free energy f₀(n) of a homogeneous fluid with the Peng-Robinson equation of state is given by:

$${f}_{0} ( n ) = {f}_{0}^{ideal} ( n ) + {f}_{0}^{excess} ( n ) , \\ {f}_{0}^{ideal} ( n ) = RT {\sum }_{i}^{M} {n}_{i} ( {lnn}_{i} - 1 ) , \\ {f}_{0}^{excess} ( n ) = - nRT ln ( 1 - bn ) + \frac{a ( T ) n}{2 \sqrt{2} b} ln ( \frac{1 + ( 1 - \sqrt{2} ) bn}{1 + ( 1 + \sqrt{2} ) bn} ) , \qquad ( 3 )$$

where R is the gas constant, having a value of 8.31432 J/(mol·K), T is the temperature of the fluid, “i” describes the components of the fluid, and M is the total number of components. Parameter a=a(T) is the pressure correction coefficient and b=b(T) is the volume correction, and they have the following expressions:

$$\begin{matrix}a ( T ) = {\sum }_{i = 1}^{M} {\sum }_{j = 1}^{M} {y}_{i} {{y}_{j} ( {a}_{i} {a}_{j} )}^{\frac{1}{2}} ( 1 - {k}_{ij} ) & ( 4 ) \\ b ( T ) = {\sum }_{i = 1}^{M} {y}_{i} {b}_{i} . & ( 5 )\end{matrix}$$

In equations (4) and (5), yᵢ represents the mole fraction of the ith component of the fluid, and kᵢⱼ represents the binary interaction of the Peng-Robison equation of state. The aᵢ and bᵢ parameters in equations (4) and (5) are given by:

$${a}_{i} ( T ) = 0.45724 \frac{{R}^{2} {T}_{ci}^{2}}{{P}_{ci}} ( 1 + {{m}_{i} ( 1 - \sqrt{\frac{T}{{T}_{ci}}} )}^{2} ) , \\ {b}_{i} = 0.7780 \frac{{RT}_{ci}}{{P}_{ci}} , \qquad ( 6 )$$

where T_{ci} and P_{ci} are the properties (i.e., the critical temperature and critical pressure) of the ith component of the fluid. The term mᵢ has the form:

mᵢ=0.37464+1.54226ωᵢ−0.26992ωᵢ², for ωᵢ≤0.49, and mᵢ=0.379642+1.4850306ωᵢ−0.164423ωᵢ²+0.016666666ωᵢ³, for ωᵢ>0.49 (7)

The parameter ωᵢ can be calculated as being:

$${ω}_{i} = \frac{3}{7} ( \frac{{log}_{10} ( \frac{{P}_{ci}}{14.695 PSI} )}{\frac{{T}_{ci}}{{T}_{bi}} - 1} ) . \qquad ( 8 )$$

The gradient contribution f_{∇}(n) can be described by the relation:

$${f}_{∇} ( n ) = \frac{1}{2} {\sum }_{i , j = 1}^{M} {c}_{ij} ∇ {n}_{i} \cdot ∇ {n}_{j} , \qquad ( 9 )$$

where cᵢⱼ is the influence parameter, which is defined by:

cᵢⱼ=(1−βᵢⱼ)\sqrt{cᵢcⱼ,} (10)

and βᵢⱼ is the binary coefficient, but it usually treated to be zero in most calculations.

However, computing the total Helmholtz energy density, which is described by equations (1) and (9), is not straightforward and is also computationally intensive because of the non-linearity of the equations. Thus, according to an embodiment, the total Helmholtz free energy F, which is the integral over a given volume in space of the total Helmholtz free energy density f(n), can be written using the Peng-Robinson equation of state as follows:

$$F = {\int }_{Ω} [ \frac{C}{2} {\vert ∇ n \vert}^{2} + {f}_{0} ] dx , \qquad ( 11 )$$

where Ω represents the considered volume, x is a three-dimensional coordinate describing a point in the volume Ω, and C is the influence parameter, similar to cᵢⱼ discussed above in equation (10). The homogenous term Eₚ of the total Helmholtz free energy F has the form:

$${E}_{p} = {\int }_{Ω} {f}_{0} d x . \qquad ( 12 )$$

To simplify the calculations of the Helmholtz free energy F for a flow of a multi-component fluid underground (which is associated with an oil and/or gas reservoir), the scalar auxiliary variable (SAV) scheme is used to introduce the following term:

r(t)=\sqrt{Eₚ+C₀,} (13)

where C₀ is a constant used to make sure that Eₚ+C₀≥0.

With the scalar auxiliary variable, the total Helmholtz free energy F can be rewritten as follows:

$$F = {\int }_{Ω} [ \frac{C}{2} {\vert ∇ n \vert}^{2} + {r}^{2} - {C}_{0} ] dx , \qquad ( 14 )$$

Then, the original problem (also called gradient flow in the art) for calculating the flow in the subsurface, which is described by equation (15),

nₜ+cΔ²n=Δμ₀, (15)

can be written as following by using equation (14),

$${n}_{t} = Δμ , \\ μ = - C Δ n + \frac{r}{\sqrt{{E}_{p} + {C}_{0}}} {μ}_{0} ( n ) , \\ {r}_{t} = \frac{1}{2 \sqrt{{E}_{p} + {C}_{0}}} {\int }_{Ω} {μ}_{0} ( n ) {n}_{t} dx , \qquad ( 16 )$$

where μ is the chemical potential,

$${n}_{t} = \frac{\partial n}{\partial t} , \\ {r}_{t} = \frac{\partial r}{\partial t} , \\ and$$

$${μ}_{0} = \frac{\partial {f}_{0}}{\partial n} .$$

With equation (16), the single-component, multi-phase system can be rewritten as:

$${n}_{t} + {C Δ}^{2} n - \frac{r}{\sqrt{{E}_{p}} + {C}_{0}} {Δμ}_{0} ( n ) = 0 , \\ and \\ {r}_{t} = \frac{1}{2 \sqrt{{E}_{p} + {C}_{0}}} {\int }_{Ω} {μ}_{0} ( n ) {n}_{t} dx . \qquad ( 17 )$$

The set of equations (17) can be discretized using, for example, a finite difference formula (which is a family of implicit methods for the numerical integration of ordinary differential equations; they are linear multistep methods that, for a given function and time, approximate the derivative of that function using information from already computed times, thereby increasing the accuracy of the approximation):

$$\frac{{n}^{k + 1} - {n}^{k}}{Δ t} + {C Δ}_{h}^{2} {n}^{k + 1} - \frac{{r}^{k + 1}}{\sqrt{{E}_{p} ( {k}^{n} ) + {C}_{0}}} {Δ}_{h} {μ}_{0} ( {n}^{k} ) = 0 , \\ and \\ {r}^{k + 1} - {r}^{k} = \frac{1}{2 \sqrt{{E}_{p} ( {n}_{k} ) + {C}_{0}}} {\int }_{Ω} {μ}_{0} ( {n}^{n} ) ( {n}^{k + 1} - {n}^{k} ) dx , \qquad ( 18 )$$

where h is the approximation, and k is an integer that describes successive values of an associated parameter (e.g., r or n) as this parameter changes in time and/or space. The evolution scheme for the molar density n can then be calculated as:

$$\begin{matrix}{n}^{k + 1} = {( 1 + {Δ tC Δ}_{h}^{2} )}^{- 1} {n}^{k} + dt \frac{{r}^{k + 1}}{\sqrt{{E}_{p} ( {n}^{k} ) + {C}_{0}}} {( 1 + {Δ tC Δ}_{h}^{2} )}^{- 1} {Δ}_{h} {μ}_{0} ( {n}^{k} ) , & ( 19 ) \\ {r}^{k + 1} = \frac{{r}^{k} + \frac{1}{2 \sqrt{{E}_{p} ( {n}^{k} ) + {C}_{0}}} {\int }_{Ω} {μ}_{0} ( {n}^{k} ) [ {( 1 + {Δ tC Δ}_{h}^{2} )}^{- 1} - 1 ] {n}^{k} dx}{1 - \frac{Δ t}{\sqrt{{E}_{p} ( {n}^{k} ) + {C}_{0}}} {\int }_{Ω} {μ}_{0} ( {n}^{k} ) [ {( 1 + {Δ tC Δ}_{h}^{2} )}^{- 1} ] {n}^{k} dx} . & ( 20 )\end{matrix}$$

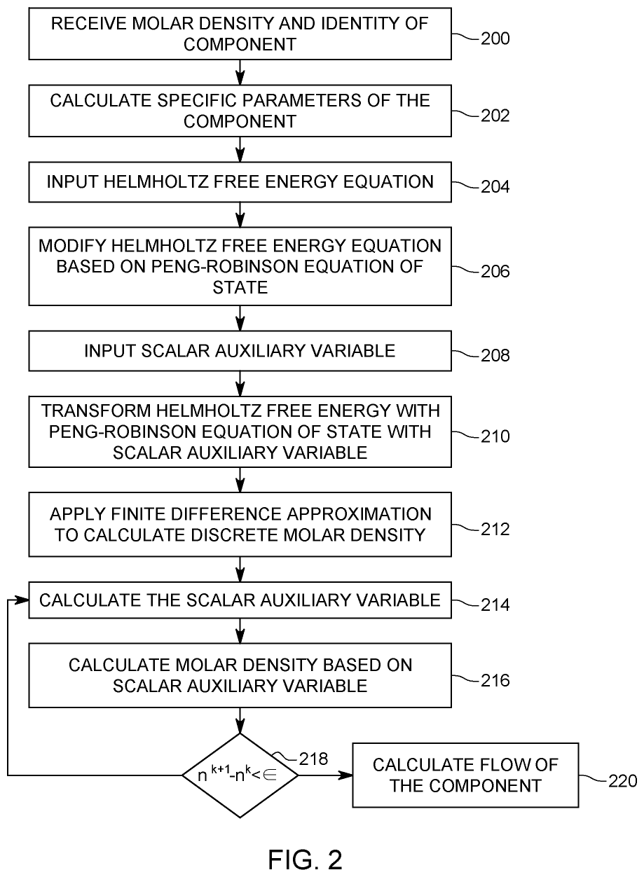

It is noted that equations (19) and (20) are now linear and thus, they do not require intensive CPU resources for solving them. A method that implements the above discussed algorithm is now discussed with regard to FIG. 2. In step 200, the molar density n^{k=0} of the single component fluid is received, as well as the identity of the single component (e.g., propane, ethene, etc.). In step 202, the parameters C, a, and b discussed above are determined for the single component. In step 204, the Helmholtz free energy of the single component is selected and in step 206, the Helmholtz free energy is modified based on the Peng-Robinson equation of state. In step 208, the scalar auxiliary variable is introduced (see equation (13)), and in step 210, the Helmholtz free energy with the Peng-Robinson equation of state (see equation (15)) is transformed based on the scalar auxiliary variable to obtain the SAV Helmholtz free energy with the Peng-Robinson equation of state (see equation (16)). Then, in step 212, the SAV Helmholtz free energy with the Peng-Robinson equation of state is discretized, for example, with a finite difference approximation, to obtain the discrete value of the molar density of the component and the variable r of the SAV scheme (see equation (18)). In step 214, the value of scalar auxiliary variable r^{k} is calculated (see equation (19)) and in step 216, the value of the molar density n^{k} is calculated (see equation (20)) based on the value of the scalar auxiliary variable r^{k}. These steps are repeated until a determination is made in step 218 that a result of the molar density converges, i.e., n^{k+1}−n^{k}≤∈, where ∈ is a small predetermined convergence criteria. When the value of the molar density converges, the loop stops at step 218, and the flow of the component is estimated in step 220, based on the molar density n^{k+1} of the component. Note that the molar densities calculated in step 216 are considered to be static values, i.e., constants at a given time. However, by being able to determine the molar densities at each point in a given volume, and plotting these values, the distribution of the fluid in the subsurface could be visualized. If the values of the molar densities are calculated at successive points in time, and these values are plotted in a dynamic way, the flow of the fluid can be visualized in step 220.

The above method may be extended to a multi-component fluid as now discussed. The multi-component fluid is considered to have “i” components, where i varies from 1 to any integer. For this case, nᵢ represents the molar density for the i-th component and μᵢ is the chemical potential for the i-th component. With this convention, the multi-component fourth-order model with the Peng-Robinson equation of state can be written as follows:

$$\frac{\partial {n}_{i}}{\partial t} + ∇ \cdot {J}_{i} = 0 , \\ and \\ {J}_{i} = - \frac{{D}_{i} \frac{{N}_{i}^{0}}{\vert Ω \vert}}{RT} ∇ {μ}_{i} , \qquad ( 21 )$$

where Nᵢ⁰ is the total particle amount of the i-th component at the initial state, and N⁰ is the total particle amount of all the components at the initial state, Dᵢ>0 is the diffusion coefficient of the i-th component, and Jᵢ is the diffusion flux. The total chemical potential μᵢ of the i-th component is a combination of two parts:

$${μ}_{i} = {μ}_{0 , i} - {\sum }_{j = 1}^{M} {c}_{ij} {Δ n}_{j} . \qquad ( 22 )$$

Similarly, the Helmholtz free energy F of the total system has two components:

F=F_{b}+F_{∇}, (23)

where the homogenous Helmholtz free energy part has the form:

F_{b}=∫_{Ω}f_{b}(n)dx, (24)

and the gradient part has the form:

F_{∇}=½∫_{Ω}cᵢⱼ∇nᵢ·∇nⱼdx. (25)

Here, the term in SAV is defined as:

$$r ( t ) = \sqrt{{F}_{b} + {\sum }_{i = 0}^{M} {C}_{T , i} {N}_{i}^{t}} . \qquad ( 26 )$$

Thus, by using equation (26), the chemical potential described by equation (22) can be rewritten as:

$${μ}_{i} = \frac{r ( t )}{\sqrt{{F}_{b} + {\sum }_{i = 0}^{M} {C}_{T , i} {N}_{i}^{t}}} {μ}_{0 , i} - {\sum }_{j = 1}^{M} {c}_{ij} {Δ n}_{j} . \qquad ( 27 )$$

The SAV discretized scheme for the multicomponent multiphase flow then becomes:

$$\begin{matrix}\frac{{n}_{1}^{k + 1} - {n}_{1}^{k}}{Δ t} - \frac{{D}_{1} \frac{{N}_{i}^{0}}{\vert Ω \vert}}{RT} \frac{{r}_{1}^{k + 1}}{\sqrt{{F}_{b}^{k} + {\sum }_{i = 0}^{M} {C}_{T , i} {N}_{i}^{t}}} {Δ}_{h} {μ}_{0 , 1}^{k} + \frac{{D}_{1} \frac{{N}_{i}^{0}}{\vert Ω \vert}}{RT} {c}_{11} {Δ}_{h}^{2} {n}_{1}^{k + 1} + \frac{{D}_{1} \frac{{N}_{i}^{0}}{\vert Ω \vert}}{RT} {c}_{12} {Δ}_{h}^{2} {n}_{2}^{k} = 0 \\ \frac{{n}_{2}^{k + 1} - {n}_{2}^{k}}{Δ t} - \frac{{D}_{2} \frac{{N}_{2}^{0}}{\vert Ω \vert}}{RT} \frac{{r}_{2}^{k + 1}}{\sqrt{{F}_{b}^{k} + {\sum }_{i = 0}^{M} {C}_{T , i} {N}_{i}^{t}}} {Δ}_{h} {μ}_{0 , 2}^{k} + \frac{{D}_{2} \frac{{N}_{2}^{0}}{\vert Ω \vert}}{RT} {c}_{22} {Δ}_{h}^{2} {n}_{2}^{k + 1} + \frac{{D}_{2} \frac{{N}_{2}^{0}}{\vert Ω \vert}}{RT} {c}_{21} {Δ}_{h}^{2} {n}_{1}^{k} = 0 , & ( 28 ) \\ {r}_{1}^{k + 1} = \frac{\begin{matrix}{r}_{1}^{k} + \frac{{μ}_{0 , 1}^{k}}{\sqrt{{F}_{b}^{k} + {\sum }_{i = 0}^{M} {C}_{T , i} {N}_{i}^{t}}} {\int }_{Ω} ( {L}_{1}^{- 1} - 1 ) {n}_{1}^{k} - \\ {L}_{1}^{- 1} ( \frac{{D}_{1} \frac{{N}_{1}^{0}}{\vert Ω \vert}}{RT} {Δ tc}_{12} {Δ}_{h}^{2} {n}_{2}^{k} ) dx\end{matrix}}{1 - \frac{\frac{{D}_{1} \frac{{N}_{1}^{0}}{\vert Ω \vert}}{RT} {Δ t μ}_{0 , 1}^{k}}{2 \sqrt{{F}_{b}^{k} + {\sum }_{i = 0}^{M} {C}_{T , i} {N}_{i}^{t}}} {\int }_{Ω} {L}_{1}^{- 1} {Δ}_{h} {μ}_{0 , 1}^{k} dx} \\ {r}_{2}^{k + 1} = \frac{\begin{matrix}{r}_{2}^{k} + \frac{{μ}_{0 , 2}^{k}}{\sqrt{{F}_{b}^{k} + {\sum }_{i = 0}^{M} {C}_{T , i} {N}_{i}^{t}}} {\int }_{Ω} ( {L}_{2}^{- 1} - 1 ) {n}_{2}^{k} - \\ {L}_{2}^{- 1} ( \frac{{D}_{2} \frac{{N}_{2}^{0}}{\vert Ω \vert}}{RT} {Δ tc}_{21} {Δ}_{h}^{2} {n}_{1}^{k} ) dx\end{matrix}}{1 - \frac{\frac{{D}_{2} \frac{{N}_{2}^{0}}{\vert Ω \vert}}{RT} {Δ t μ}_{0 , 2}^{k}}{2 \sqrt{{F}_{b}^{k} + {\sum }_{i = 0}^{M} {C}_{T , i} {N}_{i}^{t}}} {\int }_{Ω} {L}_{2}^{- 1} {Δ}_{h} {μ}_{0 , 2}^{k} dx} , & ( 29 )\end{matrix}$$

where the intermediate functions L can be defined as:

$${L}_{1} = 1 + \frac{{D}_{1} \frac{{N}_{1}^{0}}{\vert Ω \vert}}{RT} {Δ tc}_{11} {Δ}_{h}^{2} , \\ and \\ {L}_{2} = 1 + \frac{{D}_{2} \frac{{N}_{2}^{0}}{\vert Ω \vert}}{RT} {Δ tc}_{22} {Δ}_{h}^{2} . \qquad ( 30 )$$

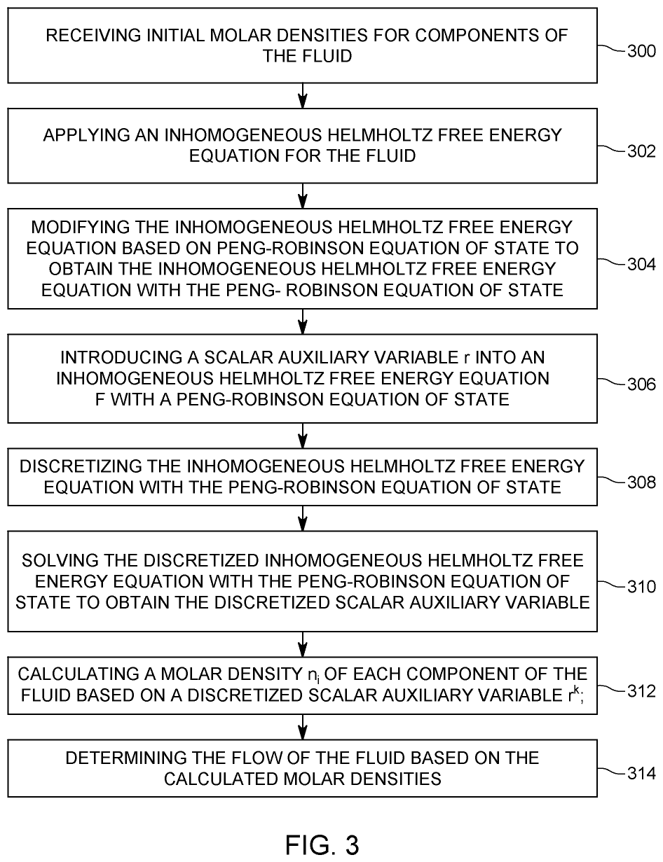

The method discussed with regard to FIG. 2 may be used with the mathematics presented in equations (21) to (30), so that a flow fora multi-component fluid can be calculated. One skilled in the art would understand that step 200 of the method would have to be changed to receive the molar density for all the components and step 202 to calculate the specific parameters of all the components. For example, such a method is illustrated in FIG. 3 and includes a step 300 of receiving initial molar densities for components of the fluid; a step 302 of applying an inhomogeneous Helmholtz free energy equation for the fluid; a step 304 of modifying the inhomogeneous Helmholtz free energy equation based on Peng-Robinson equation of state to obtain the inhomogeneous Helmholtz free energy equation with the Peng-Robinson equation of state; a step 306 of introducing a scalar auxiliary variable r into an inhomogeneous Helmholtz free energy equation F with a Peng-Robinson equation of state; a step 308 of discretizing the inhomogeneous Helmholtz free energy equation with the Peng-Robinson equation of state; a step 310 of solving the discretized inhomogeneous Helmholtz free energy equation with the Peng-Robinson equation of state to obtain the discretized scalar auxiliary variable; a step 312 of calculating a molar density nᵢ of each component of the fluid based on a discretized scalar auxiliary variable r^{k}; and a step 314 of determining the flow of the fluid based on the calculated molar densities nᵢ.

The discretizing step may include applying a finite difference algorithm. In one application, the scalar auxiliary variable r is equal to a square root of a sum of (1) a homogeneous Helmholtz energy part of the inhomogeneous Helmholtz free energy with the Peng-Robinson equation of state, and (2) a constant. The method may further include iteratively calculating the scalar auxiliary variable and the molar density until the molar density converges, and/or obtaining two linear equations for calculating the scalar auxiliary variable and the molar density.

The methods discussed herein have been tested as now discussed. First, tests were conducted on pore-scale, i.e., a single pore. In reservoir simulation, pore-scale study is important as it can represent the fundamental flow behaviors in subsurface porous media (reservoir). In oil and gas reservoir, the pore radius can be very small (micrometers or even nanometers). Thus, the flow property of the simulated fluid is not visible and for this reason, it is customary in the art, to simulate a single droplet of fluid to represent the small-scale fluid flow. The simulations discussed herein also indicate the efficiency and robustness of the algorithm that calculates the single pore.

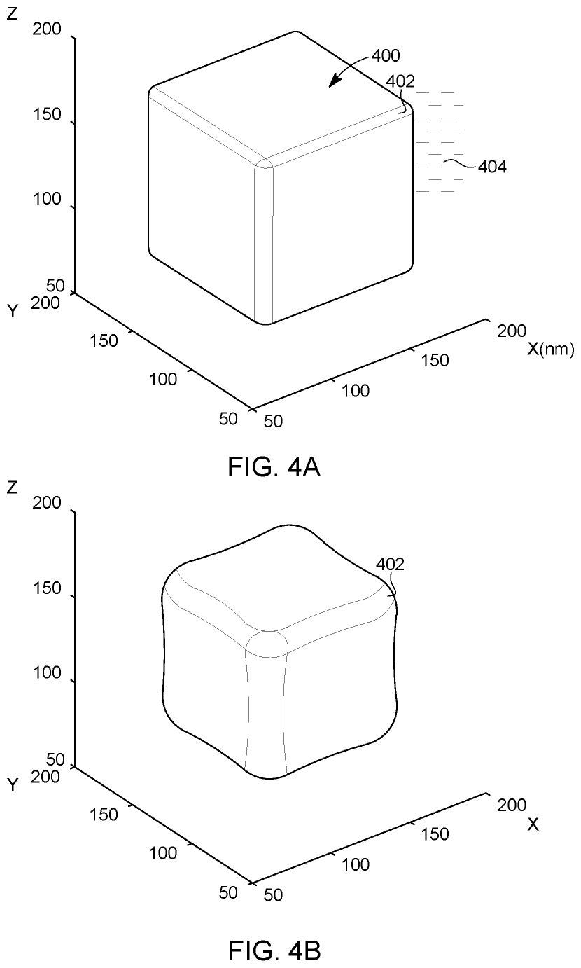

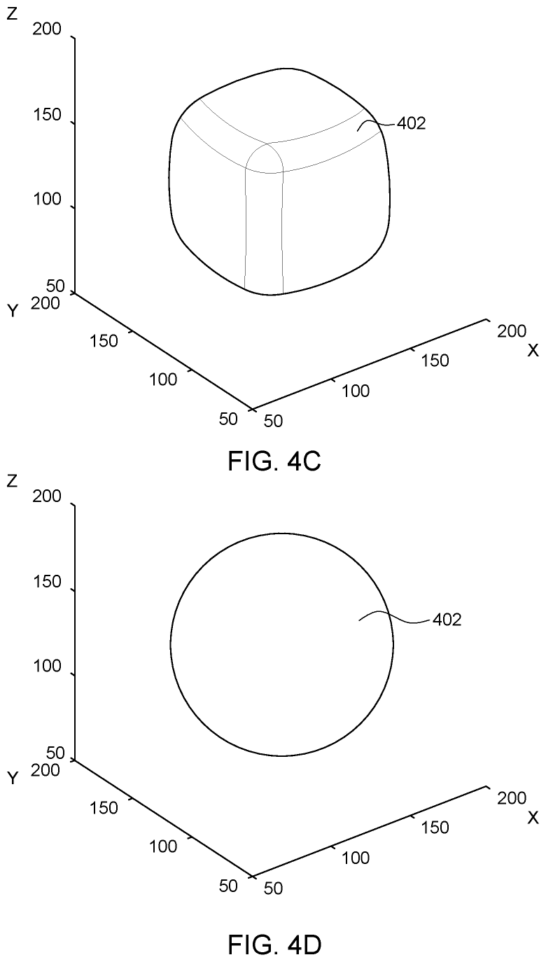

The entire domain (space volume) Ω for which the calculations are performed can be represented by a volume defined as Ω=2·10⁻⁸ m³, which is associated with the volume of a single pore located in the subsurface porous media, which is described by a uniform mesh of 200*200*200 grids and the time step is 0.0001s. FIGS. 4A to 4D show the molar density 400 calculated for a droplet 402 of liquid nC4, which is the main component of oil. The droplet (oil droplet) 402 is considered to be at T=350K in a region of about (0.3 L, 0.7 L)³, and the rest of the domain 404 is full of the nC4 in the gas phase. FIGS. 4A to 4D show the evolution history of the 3D simulation of the droplet 402, which describes a cube liquid droplet in FIG. 4A, which changes its shape into a perfect ball shape in FIG. 4D, after an iteration of 3000 steps (steps 214 and 216 in FIG. 2) performed by a computing device that implements the method. This transformation of the droplet 402 is due to the surface tension. A very short CPU time is needed for arriving at the 3D simulation shown in FIG. 4D, which indicates that the calculations performed by the computing device using this novel scheme are quick, reaching the steady state in a matter of a few minutes compared to hours or days for the existing methods. Note that FIG. 4A shows the droplet 402 after one step, FIG. 4B shows the droplet after 1000 steps, FIG. 4C shows the droplet 402 after 2000 steps and FIG. 4D shows the droplet 402 after 3000 steps.

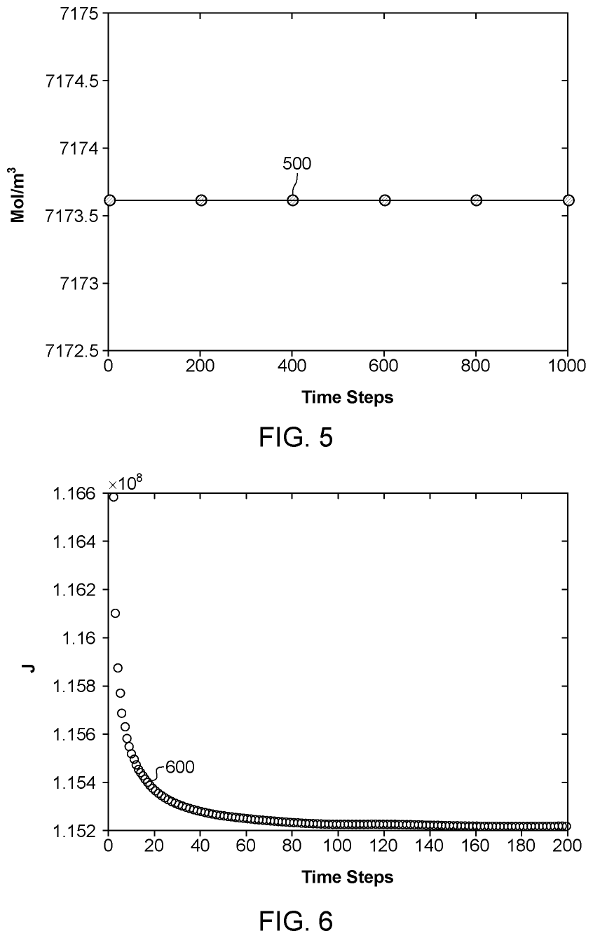

To prove the conservation property of the methods illustrated in FIGS. 2 and 3, both the mass conservation and the energy dissipation for the model discussed above is calculated, as illustrated in FIGS. 5 and 6. Note that FIG. 5 shows that the total mass 500 is conserved during the above noted computations, while FIG. 6 shows that the total free energy J 600 is dissipated, which is consistent with the 2^{nd} law of thermodynamics. Thus, the methods introduced herein conserve the mass and dissipates the total free energy, which is consistent with what is expected for a model that describes a fluid flow.

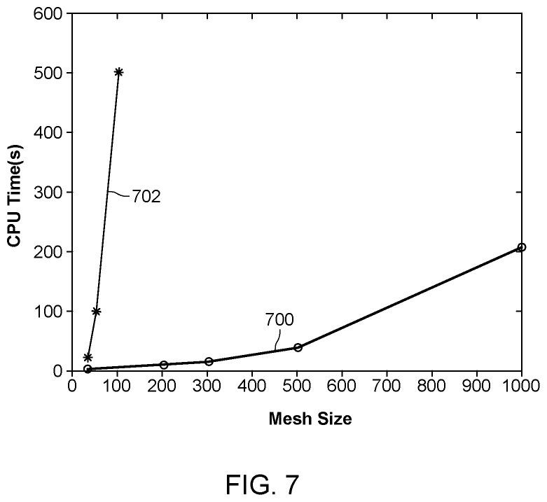

The equations derived above with the SAV scheme improve the efficiency of the computing device that implements these calculations as now discussed. The CPU time needed by the computing device for each numerical simulation with an increasing number of the mesh size is presented in FIG. 7, and compared with the traditional convex-splitting scheme [6]. It can be seen that with increasing the mesh size (plotted on the X axis), the CPU time (shown on the Y axis) needed for the convex splitting scheme 702 increases rapidly while the novel methods illustrated in FIGS. 2 and 3 show the CPU time 700 slightly increasing with the size of the mesh, indicating that a computing system that implements the novel methods can handle very large mesh sizes in an acceptable CPU time. This is due to the specific form of equations (19) and (20).

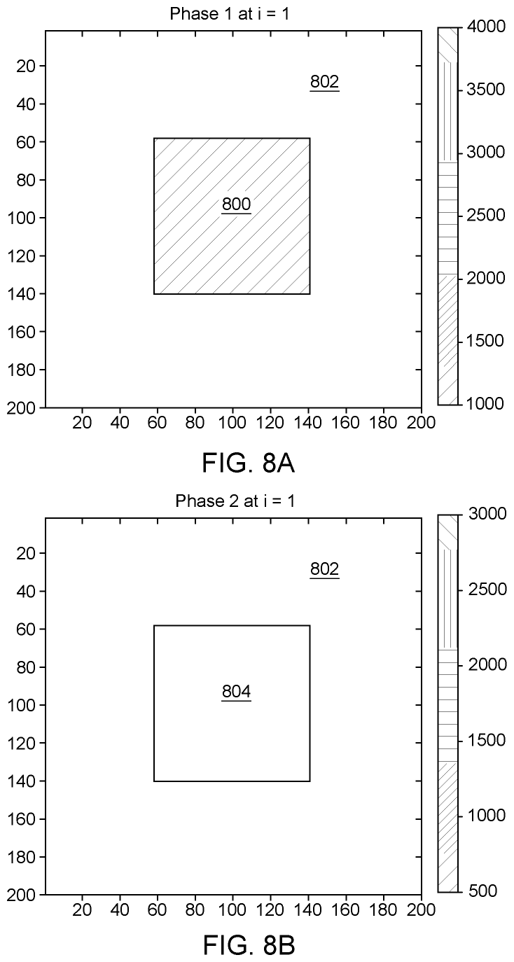

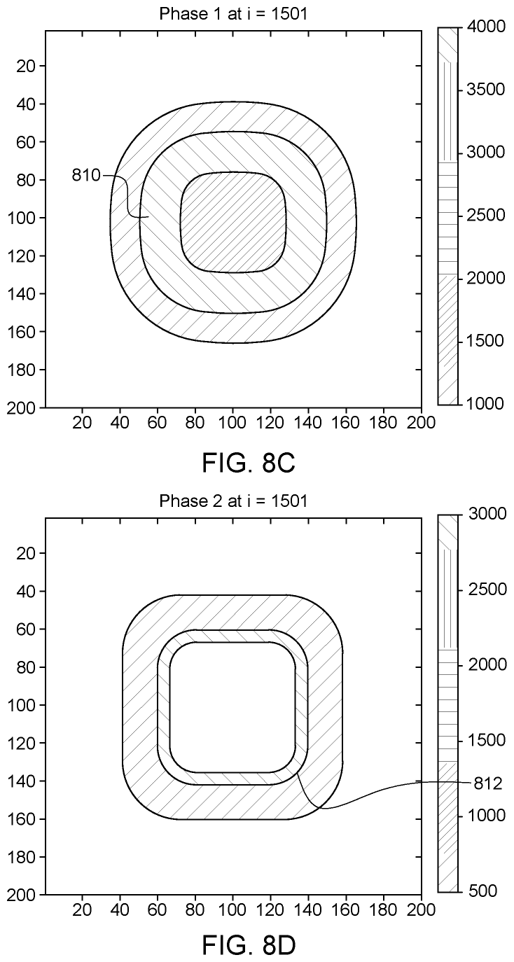

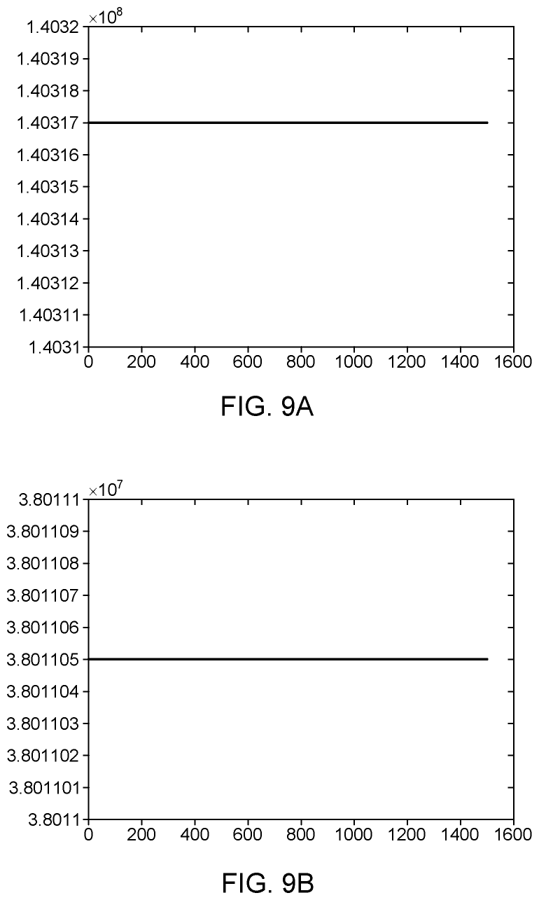

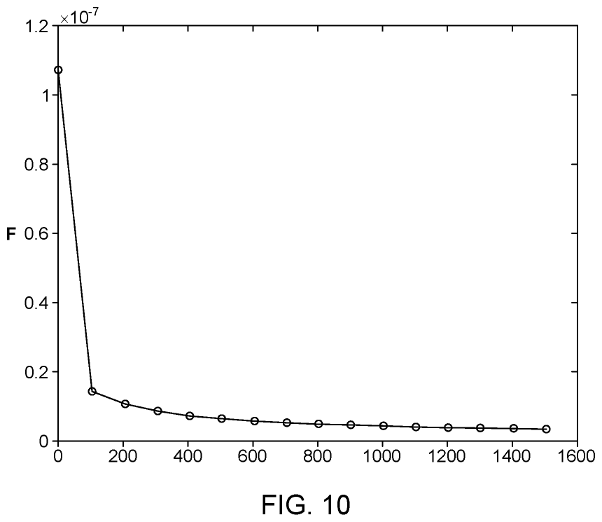

The previous examples applied the method shown in FIG. 2, i.e., for a single-component fluid. However, in realistic reservoir simulations, a multi-component fluid is usually encountered. Thus, for the next simulation, a two-phase (liquid and gas phases) binary component fluid mixture is simulated to verify the proposed method illustrated in FIG. 3. The mixture fluid consists of methane (CH₄) and n-decane (nC₁₀H₂₂). The temperature of the whole domain is assumed to stay constant at a temperature T=450 K during the simulation. The initial condition is illustrated in FIGS. 8A and 8B, which considers that there is a square liquid droplet 800 of the first component, and a square liquid droplet 804 of the second component, in the middle of the domain. A gas mixture 802 is provided for the rest of the domain. Then, as shown in FIGS. 8C and 8D, there will be a significant difference in the molar density of the liquid and gas phases of the two components. After a given number of iterations, e.g., 1500 in this example, there is a clear gas-liquid interface 810 for the first component and 812 for the second embodiment, with a certain thickness and the interface changes from a square to a circle after a certain number of iterations. Similar to the single component case, the mass for each phase is conserved (see FIGS. 9A and 9B) and the total free energy F of the fluid system dissipates (see FIG. 10).

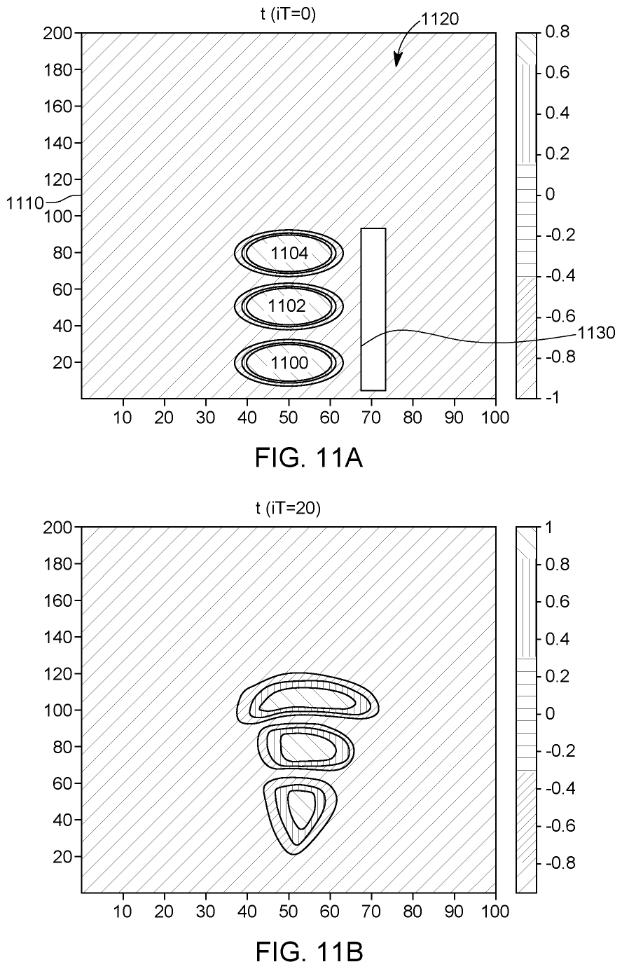

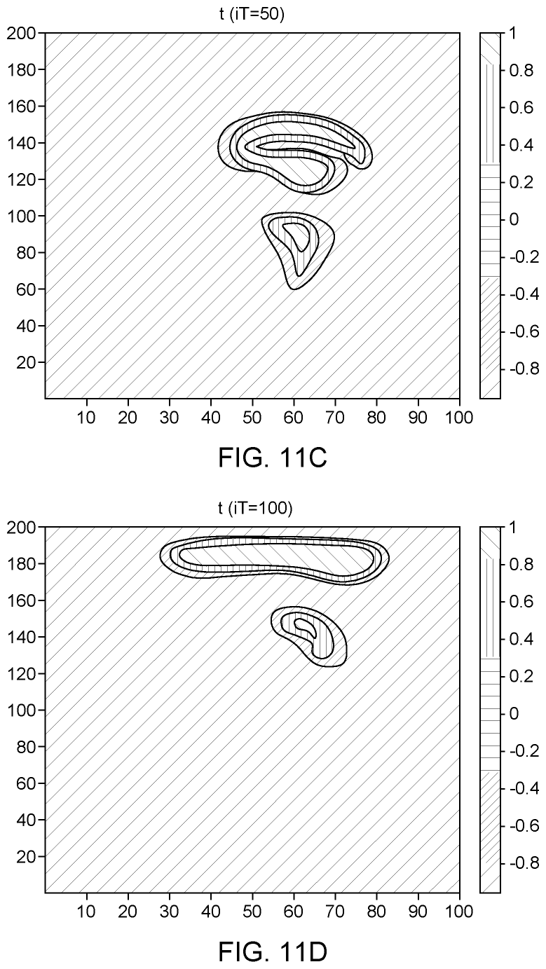

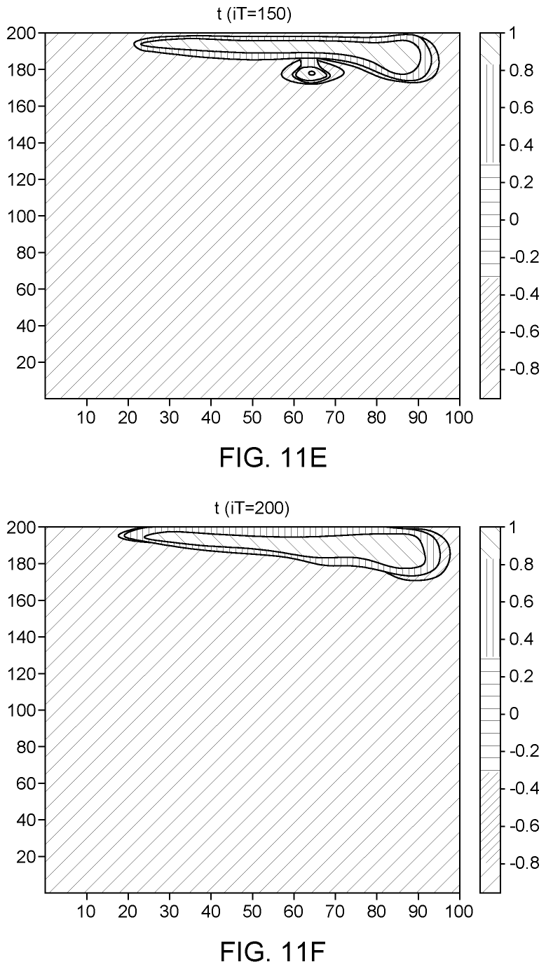

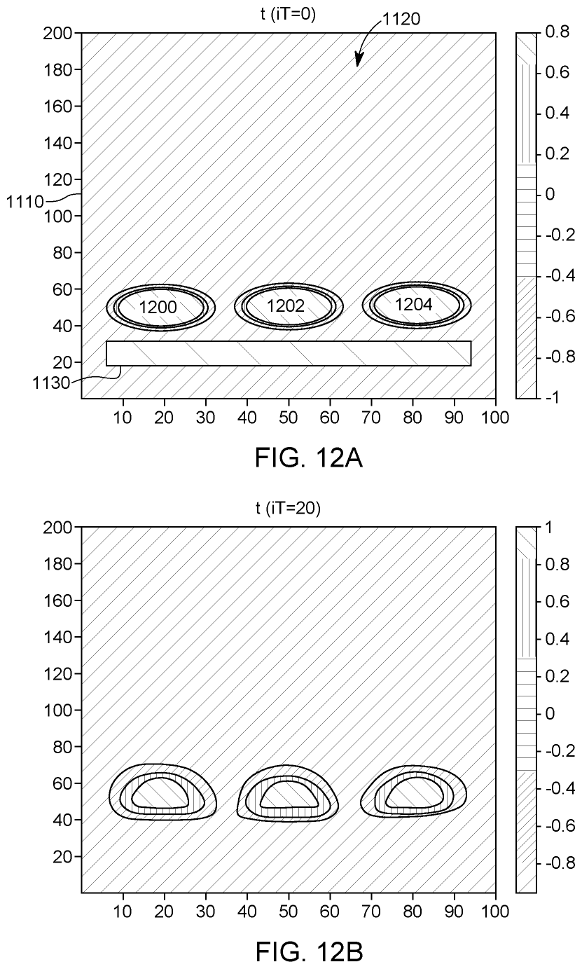

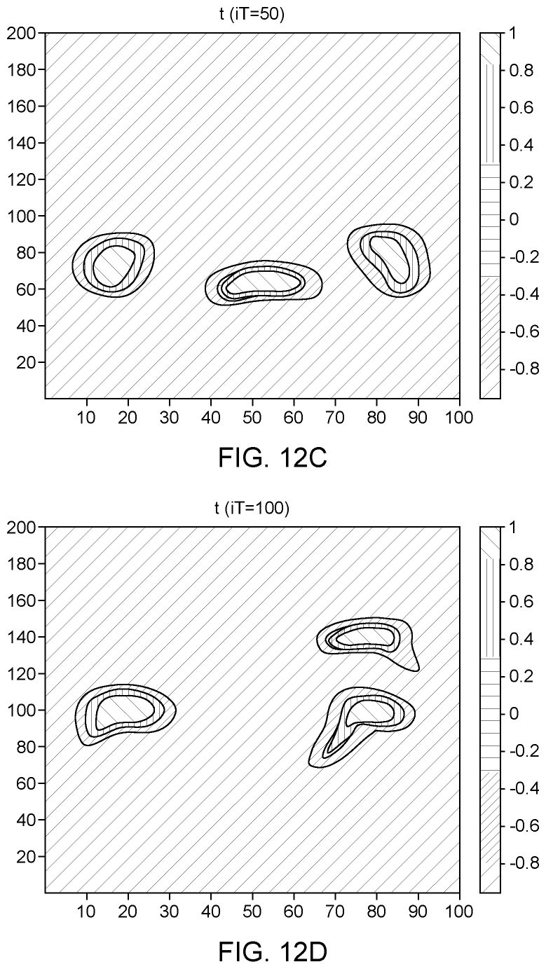

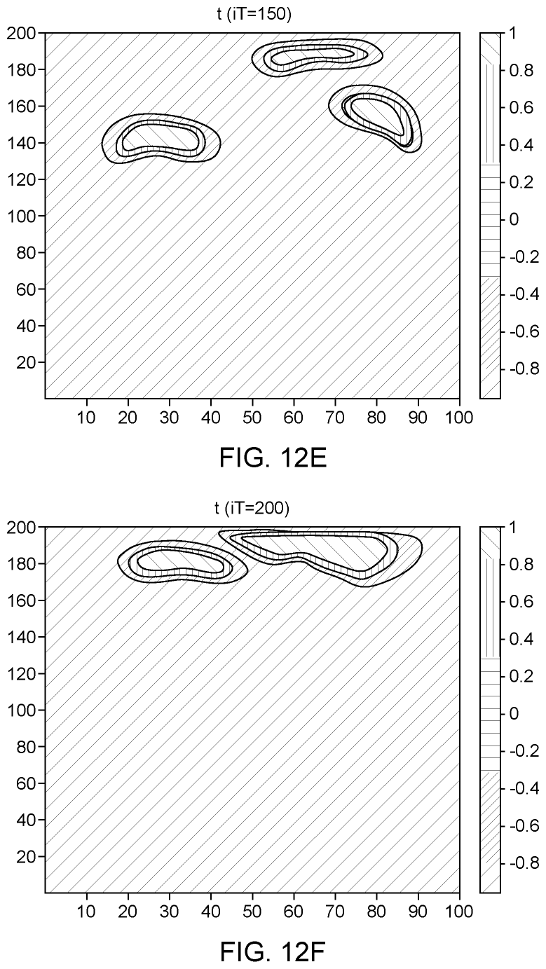

The method discussed above may be extended to simulate a multi-component, multi-phase, fluid flow at a larger scale (note that the previous figures illustrate a single pore). In this case, the oil-water separation process is simulated with several droplets. FIGS. 11A to 11F illustrate the rising and fusion process of three oil droplets 1100, 1102 and 1104 formed in a tank 1110 filled with water 1120. The initial conditions require that the droplets 1100, 1102, and 1104 are generated on an electrode plate 1130 placed vertically in the tank 1110 as shown in FIG. 11A. It can be seen that the three droplets begin to merge in FIG. 11C and they are completely merged in FIG. 11F. FIGS. 12A to 12F show similar droplets 1200, 1202, and 1204 being generated on a horizontal electrode plate 1130 (see FIG. 12A). It is noted that the rising process is faster if the plate is put vertically (reach to the tank earlier), which is preferred during separation process. A faster motion means that the oil in water can be separated faster. Note that the shape and position of the droplets in the figures are calculated based on equations (28) and (29).

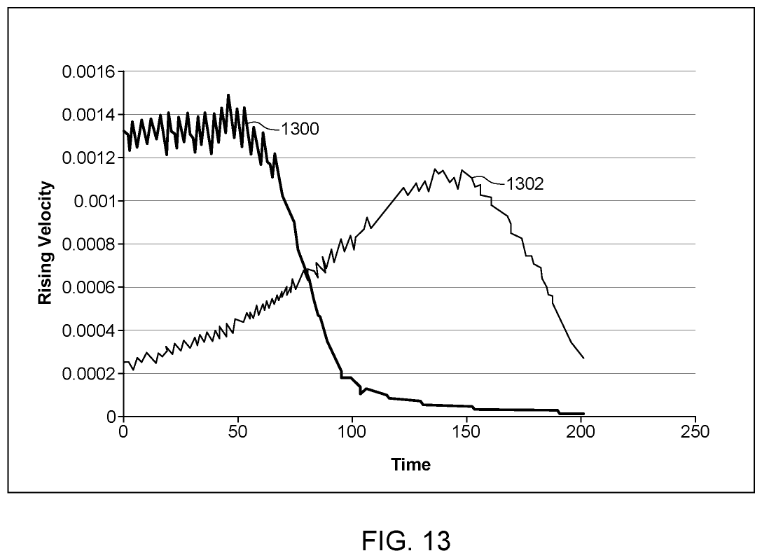

The specific velocity in each case (of FIGS. 11A to 12F) is shown in FIG. 13. It is noted that for the case having the electrode plate disposed with a vertical orientation, as illustrated in FIG. 11A, the droplets 1100, 1102, and 1104 will experience a faster velocity 1300 at the beginning, and when they reach the top, their velocity decreases to zero, while for the case having the electrode plate disposed with a horizontal orientation, as in FIG. 12A, the velocity 1302 will slowly increase from a minimum value.

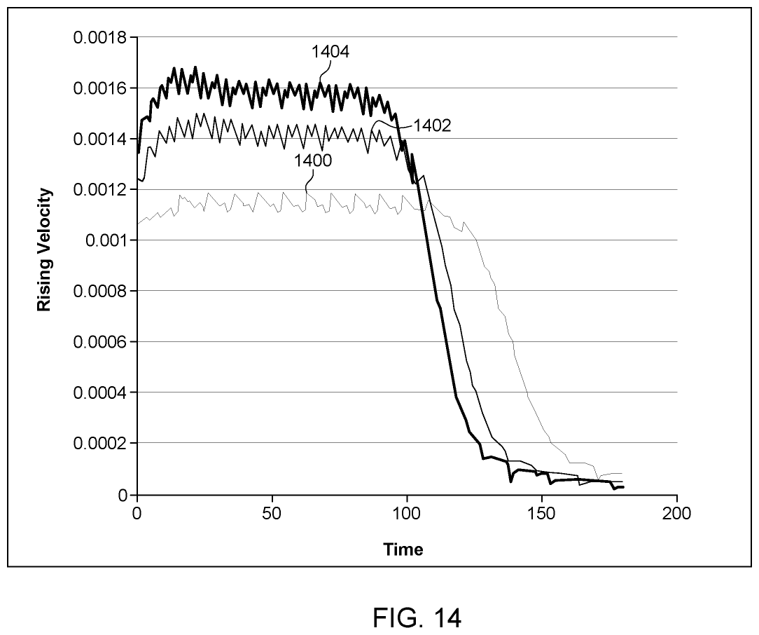

It is also possible to study the effect of temperature on the oil-water separation. In this regard, FIG. 14 illustrates the average rising velocity of the oil droplets as a function of temperature, with curve 1400 corresponding to an environment temperature of 283.15K and curve 1402 corresponding to 323.15K. It is noted that the higher the temperature, the better is for the droplet motion. This is so because a higher temperature results in a lower surface tension, which is preferred for the phase motion. Besides, if the separation tank is heated from the top (see curve 1404), the rising of droplets will be accelerated compared to the case when the tank is heated from the bottom (see curve 1402), for the same temperature 323.15K. This result can be helpful to optimize the oil-water separation process for a real well.

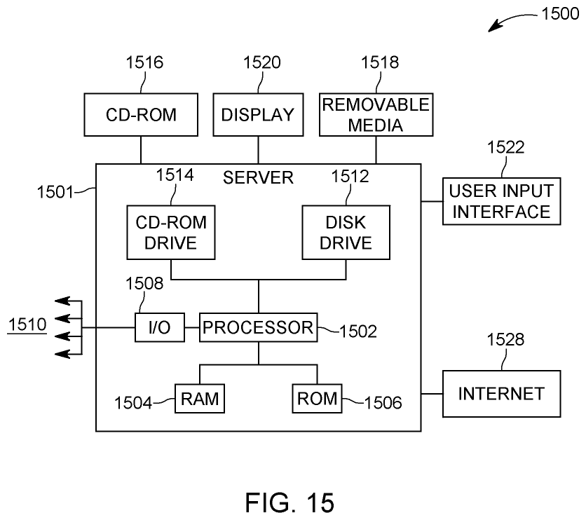

A computing device 1500 suitable for performing the activities described in the above embodiments is now discussed with regard to FIG. 15. Computing device 1500 may include a server 1501. Such a server 1501 may include a central processor (CPU) 1502 coupled to a random access memory (RAM) 1504 and to a read-only memory (ROM) 1506. ROM 1506 may also be other types of storage media to store programs, such as programmable ROM (PROM), erasable PROM (EPROM), etc. Processor 1502 may communicate with other internal and external components through input/output (I/O) circuitry 1508 and bussing 1510 to provide control signals and the like. Processor 1502 carries out a variety of functions as are known in the art, as dictated by software and/or firmware instructions.

Server 1501 may also include one or more data storage devices, including hard drives 1512, CD-ROM drives 1514 and other hardware capable of reading and/or storing information, such as DVD, etc. In one embodiment, software for carrying out the above-discussed steps may be stored and distributed on a CD-ROM or DVD 1516, a USB storage device 1518 or other form of media capable of portably storing information. These storage media may be inserted into, and read by, devices such as CD-ROM drive 1514, disk drive 1512, etc. Server 1501 may be coupled to a display 1520, which may be any type of known display or presentation screen, such as LCD, plasma display, cathode ray tube (CRT), etc. A user input interface 1522 is provided, including one or more user interface mechanisms such as a mouse, keyboard, microphone, touchpad, touch screen, voice-recognition system, etc.

The server may be part of a larger network configuration as in a global area network (GAN) such as the Internet 1528, which allows ultimate connection to various landline and/or mobile computing devices.

The disclosed embodiments provide methods and systems for determining a fluid flow in various conditions, for example, in the subsurface of the Earth. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

[1] D.-Y. Peng and D. B. Robinson. A new two-constant equation of state. Industrial Engineering Chemistry Fundamentals, 15(1):59-64;
[2] C. M. Elliott and A. Stuart. The global dynamics of discrete semilinear parabolic equations. SIAM journal on numerical analysis, 3(6):1622-1663;
[3] T. Jindrova and J. Mikyska. Fast and robust algorithm for calculation of two-phase equilibria at given volume, temperature, and moles. Fluid Phase Equilibria, 353:101-114;
[4] J. Kou and S. Sun. Thermodynamically consistent modeling and simulation of multi-component two-phase ow with partial miscibility. Computer Methods in Applied Mechanics and Engineering, 331:623-649; and
[5] Onuki, A. Dynamic van der Waals theory. Physical Review E, 75(3), 036304, 2007.
[6] Q. Peng. A convex-splitting scheme for a diffuse interface model with Peng-Robinson equation of state. Advances in Applied Mathematics and Mechanics, 9(5):1162-1188.

1. A method for calculating a fluid flow in a given underground medium, the method comprising:
receiving initial molar densities for components of the fluid;
introducing a scalar auxiliary variable r into an inhomogeneous Helmholtz free energy equation F with a Peng-Robinson equation of state;
calculating a molar density nᵢ of each component of the fluid based on a discretized scalar auxiliary variable r^{k}; and
determining the flow of the fluid based on the calculated molar densities nᵢ.

2. The method of claim 1, further comprising:
applying an inhomogeneous Helmholtz free energy equation for the fluid; and
modifying the inhomogeneous Helmholtz free energy equation based on the Peng-Robinson equation of state to obtain the inhomogeneous Helmholtz free energy equation with the Peng-Robinson equation of state.

3. The method of claim 2, further comprising:
discretizing the inhomogeneous Helmholtz free energy equation with the Peng-Robinson equation of state.

4. The method of claim 3, further comprising:
solving the discretized inhomogeneous Helmholtz free energy equation with the Peng-Robinson equation of state to obtain the discretized scalar auxiliary variable.

5. The method of claim 3, wherein the discretizing step includes applying a finite difference algorithm.

6. The method of claim 1, wherein the fluid is a multi-component, multi-phase fluid.

7. The method of claim 1, wherein the scalar auxiliary variable r is equal to a square root of a sum of (1) a homogeneous Helmholtz energy part of the inhomogeneous Helmholtz free energy with the Peng-Robinson equation of state, and (2) a constant.

8. The method of claim 1, further comprising:
iteratively calculating the scalar auxiliary variable and the molar density until the molar density converges.

9. The method of claim 1, further comprising:
obtaining two linear equations for calculating the discretized scalar auxiliary variable and the discretized molar density.

10. A computing device for calculating a fluid flow in a given underground medium, the computing device comprising:
an interface for receiving initial molar densities for components of the fluid; and
a processor connected to the interface and configured to,
apply a scalar auxiliary variable r to an inhomogeneous Helmholtz free energy equation with a Peng-Robinson equation of state;
calculate a molar density nᵢ of each component of the fluid based on a discretized scalar auxiliary variable; and
determine the flow of the fluid based on the calculated molar densities nᵢ.

11. The device of claim 10, wherein the processor is further configured to:
receive an inhomogeneous Helmholtz free energy equation for the fluid; and
modify the inhomogeneous Helmholtz free energy equation based on Peng-Robinson equation of state to obtain the inhomogeneous Helmholtz free energy equation with the Peng-Robinson equation of state.

12. The device of claim 11, wherein the processor is further configured to:
discrete the inhomogeneous Helmholtz free energy equation with the Peng-Robinson equation of state.

13. The device of claim 12, wherein the processor is further configured to:
solve the discretized inhomogeneous Helmholtz free energy equation with the Peng-Robinson equation of state to obtain the discretized scalar auxiliary variable.

14. The device of claim 12, wherein the discretizing step includes applying a finite difference algorithm.

15. The device of claim 10, wherein the fluid is a multi-component, multi-phase fluid.

16. The device of claim 10, wherein the scalar auxiliary variable r is equal to a square root of a sum of (1) a homogeneous Helmholtz energy part of the inhomogeneous Helmholtz free energy with the Peng-Robinson equation of state, and (2) a constant.

17. The device of claim 10, wherein the processor is further configured to:
iteratively calculate the scalar auxiliary variable and the molar density until the molar density converges.

18. The device of claim 11, wherein the processor is further configured to:
obtain two linear equations for calculating the discretized scalar auxiliary variable and the discretized molar density.

19. A non-transitory computer readable medium including computer executable instructions, wherein the instructions, when executed by a processor, implement instructions for calculating a fluid flow in a given underground medium, the instructions comprising:
receiving initial molar densities for components of the fluid;
introducing a scalar auxiliary variable r into an inhomogeneous Helmholtz free energy equation F with a Peng-Robinson equation of state;
calculating a molar density nᵢ of each component of the fluid based on a discretized scalar auxiliary variable r^{k}; and
determining the flow of the fluid based on the calculated molar densities nᵢ.

20. The medium of claim 19, further comprising:
applying an inhomogeneous Helmholtz free energy equation for the fluid;
modifying the inhomogeneous Helmholtz free energy equation based on Peng-Robinson equation of state to obtain the inhomogeneous Helmholtz free energy equation with the Peng-Robinson equation of state;
discretizing the inhomogeneous Helmholtz free energy equation with the Peng-Robinson equation of state; and
solving the discretized inhomogeneous Helmholtz free energy equation with the Peng-Robinson equation of state to obtain the discretized scalar auxiliary variable.
